(19) United States
(12) Patent Application Publication
(10) Pub. No.: US 2007/0087085 A1
(43) Pub. Date: Apr. 19, 2007

(54) Protein-containing food product and coating for a food product and method of making same

(75) Inventors: Monoj Sarma, Bourbonnais, IL (US); Roger L. Daniels, Manhattan, IL (US)

Correspondence Address: JONES DAY, 77 WEST WACKER, CHICAGO, IL, 60601-1692, US

(73) Assignee: Bunge Oils, Inc., St. Louis, MO (US)

(21) Appl. No.: 11/251,654

(22) Filed: Oct. 17, 2005

(51) Int. Cl. A23L 1/00

(52) U.S. Cl. 426/99

(57) ABSTRACT

A composition comprising about 10-65 weight % of a protein particulate material, about 35-90 weight % of a lipid-containing material, and no more than small amounts of an emulsifier, can be used as a coating composition for a food product, or as an ingredient in a coating composition for a food product. When used as a coating for a snack food item such as a protein-containing energy bar, the coating can add to the nutritive value of the bar, and maintain the moisture content of the bar. A method for making the composition includes the steps of adding finely ground particulate protein matter to a fat composition with heat and high shear, then cooling the composition.

### BACKGROUND OF THE INVENTION

This invention relates to an edible solid coating for a food product, the coating enhanced protein content to provide greater nutritional benefit to the consumer, compositions that can be used in the preparation of such solid coatings. This on further relates to a method for making such a composition, and to food articles such solid coatings. This invention further relates to a food product comprising composition. Many snack food items produced by the food industry are provided with a coating. Such coatings are used to maintain a desired moisture content in the coated food article, and to provide additional qualities to the food article that will enhance consumer appeal, such as flavor and mouth feel. Such coatings typically comprise fats, sugars, and other flavor enhancers.

In recent years, there has been increasing concern about high levels of consumption of both fat and sugar, and a corresponding concern about lower levels of protein consumption. The food industry has provided a variety of products intended to address those concerns. One such food product that has gained in popularity in recent years a snack bar made with enhanced nutrients, and especially a higher protein content. In standard confectionery items, protein comes from four main sources—milk, egg whites, soya and grains. The protein content in these standard items is relatively low, typically about 5.7% of total calories in soft nougat and about 2.3% of total calories in caramel. For nutritionally enhanced functional confections, in which protein levels are about 20-30% of total calories, concentrated protein sources are required (Jeffery, Maruice, S. “Functional Confectionery Technology”; The Manufacturing Confectioner: August, 2004; pp. 51.52. ) These bars are known to consumers variously as “energy bars,” nutrition bars,” “health bars,” and “sports bars.” They are intended to provide sustained energy and enhanced nutritional value, to the consumer. The concentrated protein in such bars is hygroscopic, and can absorb moisture from the other ingredients in the bar, making the bar hard and less appealing to the consumer. Increased protein can make it difficult to maintain a desired moisture level in the bar. Some energy bar products are provided with a coating to help maintain the moisture level of the bar. Such coatings typically include sugar, fat, cocoa powder, non fat dry milk, salt, and lecithin. In some products, the sugar may be replaced with one or more sugar alcohols, such as maltitol or lactitol and other artificial sweeteners such as sucralose, saccharin and aspartame. It would be desirable to provide a coating with a higher protein content for such products to provide an additional health benefit to consumers.

U.S. Pat. No. 3,514,297 discloses a continuous process of preparing powdered fat.

U.S. Pat. No. 4,212,892 discloses a high-protein snack food comprising a plastic protein gel that can be mixed with a dry starch or flour to obtain a homogeneous mass that can be extruded into desired shapes and cooked. The cooked product can be prepared in the form of chips and coated subsequent to cooking with flavoring and/or flavor-enhancing agents.

U.S. Pat. No. 4,762,725 discloses a non-aqueous, lipid-based, stable, flavored spreadable coating or filling having a smooth, non-grainy texture, spreadable at room temperature but capable of form retention when applied to a substrate at a temperature up to about 110° F., the coating comprising about 10-70% of a hydrogenated vegetable oil, about 30-90% of a particulate friable, non-hygroscopic bulking agent, flavoring, and about 0.1 to about 8% of a lipid stabilizer having a Capillary Melting Point in the range of about 125°-150° F., the vegetable oil and lipid stabilizer defining on cooling a lipid matrix for the bulking agent, the bulking agent being substantially impalpable in the lipid matrix. At column 11, lines 60 et seq., the patent states that the essence of its invention is the discovery that a spreadable filling can be made using an oil rather than shortening by stabilizing the oil with a high melting point lipid. The bulking agent is preferably selected from the group consisting of cocoa powder, dried cheese powder, bland dairy-protein, bland vegetable protein, bland corn syrup solids, and combinations thereof.

U.S. Pat. No. 4,767,637 discloses a crumb coating for foods in which a liquid batter is coagulated into a sheet, the sheet is deep fat fried, and the fried sheet is milled into crumbs.

U.S. Pat. No. 4,851,248 discloses a process of making a confectionery product having discrete articles applied to the outer surface and then coated with a suitable confectionery coating.

U.S. Pat. No. 5,258,187 discloses a food coating comprising rice starch.

U.S. Pat. No. 5,401,518 discloses a coating formed from an emulsion prepared by homogenizing from about 70% to 90% by weight of an aqueous solution of a protein isolate and from about 30% to about 5% by weight of a mixture of a saturated lipid having a melting point higher than 30° C., and an emulsifier. The homogenization may be carried out with various homogenization apparati known to those skilled in the art, which include apparati known as a “high shear” type of apparati, and for periods ranging from one minute to about 30 minutes. The emulsifier is in an amount of from about 5% to about 30% by weight based upon the weight of the lipid and contains at least one diacetyl tartaric acid ester of a monoglyceride.

U.S. Pat. No. 5,431,945 discloses a process for the preparation of a dry butter flake product having a high milk fat content.

U.S. Pat. No. 5,753,286 discloses a two-part coating for a food product. The first part of the coating is a predust which contains a starch that is suitable for film forming and a water-soluble edible setting agent. The second part of the coating is a water-containing batter which contains dextrin and a composition which is settable by the setting agent in the first part of the coating. The finished coating is an oil and moisture barrier, and is crunchy.

U.S. Pat. No. 6,932,966 B2 discloses an apparatus and method for preparing solid flakes of fats and emulsifiers, the method allowing the application of a coating to the flake to assist in voiding loss of flake separation and to maintain pourability of the flaked product.

### SUMMARY OF THE INVENTION

It is thus one object of the invention to provide a method of making a composition having enhanced protein content and which can be used as a solid food coating or in the preparation of a solid food coating, wherein the protein forms a stable emulsion with a lipid-containing material, with no more than small quantities of an emulsifier.

It is another object of the invention to provide a composition that can be used as a solid food coating or in the preparation of a solid food coating, the composition having enhanced protein content, and no more than a small quantity of an emulsifier.

It is still another object of the invention to provide a food article having a coating with an enhanced protein content, and no more than small amounts of emulsifiers.

It is still another object of the invention to provide a food product such as a snack product and having enhanced protein content.

Other objects, advantages, and novel features of the invention will be apparent from the following description and the Examples of the present invention set forth herein.

In accordance with the invention, a method for forming a composition of a protein particulate material and a lipid-based material comprises the steps of applying heat and a high shear force to the lipid material, admixing the protein particulate material into the lipid material under high shear to form an emulsion of protein material particles in the lipid material, and cooling the admixed composition, the admixed composition being suitable for use as an edible solid food coating, or as an ingredient for an edible solid food coating. The high shear can be applied by a mixer that operates in the range of about 4000-8000 rotations per minute. The lipid material is heated to a temperature in the range of 125-165° F. The lipid containing material can be derived from vegetable or animal sources. It can be non-hydrogenated, partially hydrogenated, fully hydrogenated, fractionated or interesterified, depending on the lipid material used and the desired properties of the final coating product. The protein material is in particulate form, preferably in the range of about 30-70 microns.

The invention further relates to an edible composition containing fat and protein and suitable for use as a solid coating on a food product or in the preparation of a solid coating for a food product, the composition comprising an emulsion of about 10-65 weight % of a protein particulate material in about 35-90 weight % of a lipid-containing material, and no more than small quantities of an emulsifier. The lipid-containing material can be selected from common domestic oils such as corn oil, cottonseed oil, soybean oil, and the like, or off-shore oils, such as palm oil, palm kernel oil, coconut oil, and the like. The lipid-containing material can be fully hydrogenated, partially hydrogenated, or non-hydrogenated, depending on the particular characteristics desired in the final coating product. The protein-containing material can be a whey product, a casein product, a soy protein product, or other protein product. Whey protein hydrolysates are preferred. The composition also can be used in the manufacture of a protein-enriched food product such as a snack product.

### DETAILED DESCRIPTION OF THE INVENTION

In the following detailed description of the invention, all percentages are given in terms of weight percent.

The present invention relates to a process for making an edible solid food coating having a high protein content. A lipid-containing material is subjected to high shear and heat sufficient to increase the viscosity of the system. A protein particulate stream is added to the lipid-containing material while the material is undergoing high shear, and the high shear is maintained for a period of time sufficient to create a dispersion of protein particles. The combined composition is then cooled. Due to the increase in viscosity of the composition upon heat and shearing action, the composition will form upon cooling a solid protein/fat matrix, with properties and consistency similar to solid confectionery fats. The solid composition can be provided either as a mass, or in solid cubes, or comminuted into flakes, or presented in a semi-solid or liquid form to be used as an ingredient in the manufacture of a finished solid coating.

In the practice of the present invention, a lipid-containing material is added to a high-shear mixer, such as a Lightnin mixer. Such mixers can operate at mixing speeds in the range of about 4000-12,000 rotations per minute or higher; a preferred range for the method of the present invention is about 4000-8000 rotations per minute. The lipid-containing material is heated to a temperature of about 125-165° F. and preferably about 130° F. Once the lipid-containing material is heated through, a stream of particulate protein-containing material is added to the mixer, such as by an auger feeder. The lipid-containing material and protein containing material are mixed together for a period of time sufficient to create a thick suspension of the protein particles in the matrix of lipid-containing material. Typically, mixing will continue for about 20-30 minutes. The lipid will surround each protein particle, causing the protein to soften somewhat. The mixed composition is cooled first to a temperature of about 110° F., then cooled and crystallized through a crystallizer unit (commercial name: VOTATOR) to a temperature of about 45-52° F. or less to a semi-solid. As the material crystallizes it releases the heat of crystallization, raising the temperature of the composition to about 65-70° F. The product is then collected in a cube for final hardening as a confectionery fat. Alternatively, the mixed protein-fat composition at around 110° F. can be fed into a flaking roll system to yield a protein/fat composition in the form of flakes for later use.

The lipid-containing product used in the composition can be present in the amount of about 35-90% of the composition, preferably in the amount of about 35-65% of the composition, and most preferable about 50% of the composition. The lipid-containing product can be a domestic oil product, such as corn oil, canola oil, cottonseed oil, soybean oil, sunflower oil, peanut oil, and olive oil. Alternatively the lipid-containing product can be an off-shore oil product such as palm kernel oil, fractionated palm kernel oil, palm kernel stearine, coconut oil, and palm oil. Both the domestic and off-shore oil products can be used in their non-hydrogenated, partially hydrogenated, or hydrogenated forms, depending on the characteristics of the coating that may be desired. Fractionated and interesterified products also can be used. In some embodiments it may be desirable to avoid hydrogenated lipid products to avoid the introduction of trans fats into the product for nutritional reasons. Cocoa butter, butter fat, and dairy fat also can be used. Commercially available oil products that have been found to be suitable for use in the method of the present invention include a refined, bleached, and deodorized (i.e., RBD) palm kernel oil sold by Fuji under the name DF #14; a fractionated palm kernel stearine sold by Arrhus under the name CE 21-20, and a palm kernel stearine sold by Premium Vegetable Oils Berhad (PVO) under the name PKS 75. Other suitable lipid-containing materials will be recognized by those skilled in the art. Blends of any of the foregoing also can be selected to provide a desired melting point and solid fat content profiles over a range of operating temperatures.

The following fats and blends were evaluated to determine their suitability for use in the present invention, by determining their melting points and solid fat contents over a range of temperatures as set forth in table I below.

TABLE I
Evaluation of Lipid-Containing Products

| | | Mettler Drop | SFC (Solid | | | | |
|---|---|---|---|---|---|---|---|
| | | Point (MDP) | Fat Content) | | | | |
| Example | Type | (° C.) | 10° C. | 21.1° C. | 26.7° C. | 33.3° C. | 40.0° C. |
| 1 | PKO* | 31 | 70.6 | 41.0 | 9.9 | 0.1 | 0.8 |
| 2 | Fract. PKS** | 35 | 87.7 | 73.5 | 49.8 | 0.3 | 0.4 |
| 3 | PKS*** | 37 | 90.6 | 81.6 | 61.7 | 1.3 | 0.2 |
| 4 | 80% Ex1/20% Ex3 | 32.3 | 73.1 | 50.1 | 18.7 | 0.6 | 0.1 |
| 5 | 50% Ex1/50% Ex3 | 34.1 | 79.1 | 62.5 | 34.4 | 0.4 | 0.2 |
| 6 | 20% Ex 1/80% Ex 3 | 36.0 | 85.2 | 73.5 | 50.9 | 0.1 | 0.4 |

*Refined, bleached deodorized palm kernel oil, Fuji DF #14
**Fractionated palm kernel stearine, Arrhus CE 21-20
***Palm kernel stearine, PVO PKS 75 - Source Premium Vegetable Oils, Berhad, Malaysia

Of the foregoing fats and blends, the most suitable products in terms of coating viscosity, setting time, adherence, and finished product stickiness were those made using the fractionated palm kernel oil product and the blend of 20% DF #14 (RBD palm kernel oil) and 80% PKS 75 (palm kernel stearine). Unblended palm kernel oil could be used to make a softer product.

The fat compositions of Examples 1, 2, 4, 5, and 6 were evaluated for their suitability for use as an ingredient in the preparation of solid coatings. For each of these fat compositions, a corresponding coating composition was prepared in a 4-quart, hot water jacket Hobart bowl as follows: 926.1 grams sugar, 285.1 grams natural cocoa powder (10-12% fat), 54.5 grams non-fat dry milk and 1.4 grams of extra-fine salt were blended together. These dry ingredients were then blended with 272.5 grams of the fat composition that had been heated in the same bowl to a temperature of about 105° F. at Hobart bowl speed #1. This blended complex was then ground through a 3-roll mill to reduce the particle size. The ground material was then blended into another 272.5 grams of the fat composition in the same bowl that had been heated to 125° F., along with from 3.63-5.45 grams soybean lecithin as emulsifier and mixed at Hobart bowl speed #1 for 30 minutes. The composition was then cooled to 120° F., coated on to individual bars, and the coated bars were run through a cooling tunnel for 7.5 minutes at a temperature of 57-60° F. Each of the fats was found to make an acceptable solid coating product, with variations in gloss, stickiness, and time to set while in the cooling tunnel.

The protein-containing product can be present in the amount of about 10-65% of the composition, preferably in the amount of about 35-65% of the composition, and most preferable about 50% of the composition. The protein-containing product can be, for example, whey protein concentrate, whey protein isolate, whey protein hydrolysate, soy isolate, soy concentrate, milk casein, calcium caseinate, calcium sodium caseinate, milk protein isolates, beta-lacto globulin, and alpha-lactalbumin. The protein is preferably provided in the form of a finely ground powder. Whey hydrolysate is particularly preferred. One suitable whey protein hydrolysate product is Hilmar 8360 Instantized Whey Protein Hydrolysate (80% net protein), sold by Hilmar Ingredients of Hilmar, Calif.

The protein particles are in the range of about 30-70 microns, and preferably as low as about 10 microns. Generally, smaller particle size provides greater benefit in terms of product sheen and overall appearance as the percentage of protein in the composition increases. Small particle size also promotes dispersion of the protein in the lipid matrix. When such fine particles are admixed with the lipid-containing materials with high shear and heat, the particles are softened by the lipid-containing material and remain dispersed without settling. A small amount of an emulsifier may be used to maintain the dispersion of the protein particles in the lipid-containing material. Suitable emulsifiers include lecithin and poly glycerol poly ricinoleate. The emulsifiers can be added in the amounts of about 0.6% or less.

When the step of mixing with heat and high shear is complete, the admixed composition is cooled first to about 110° F., and then placed in a cooling chamber having a temperature of about 0-32° F., and preferably about 25° F. Upon cooling, the admixed composition will form a fat-protein complex suitable for use as a confectionery fat. This product can be cubed, or passed through flaking rolls to be comminuted into flakes. The cubes or flakes can be used in the preparation of a high-protein coating product such as for an energy bar snack food.

The following examples in Table II illustrate the process of manufacturing a composition in accordance with the invention. In each of the following examples, the fat component was fractionated palm kernel oil sold under the name CE 21-20 by Arrhus, and the protein component was whey protein hydrolysate with 80% net protein, sold under the name Hilmar 8360 by Hilmar Ingredients. Each composition was mixed for 20 minutes at a temperature of 130° F., and was cooled to 110° F. before being placed in the freezer. The viscosity of each composition was measured at 130° F. in units of centipoise on a Brookfield Instrument (model DV-I+Viscometer) spindle-3/rpm 20.

TABLE II
Preparation of Fat/Protein Complex

| Example | Description | Composition | | Mixing speed | | Viscosity |
|---|---|---|---|---|---|---|
| 7 | 0% protein (control) | 1500 | gms fat | 2000 | rpm | 900-1100 cp |
| 8 | 30% net protein | 563 | grams protein | 4000-6000 | rpm | 1460-1800 cp |
| | | 937 | grams fat | | | |
| 9 | 40% net protein | 750 | gms protein | 4000-6000 | rpm | 2800-3000 cp |
| | | 750 | gms fat | | | |
| 10 | 50% net protein | 935 | gms protein | 5000-7000 | rpm | 3500-4000 cp |
| | | 565 | gms fat | | | |

The compositions of Examples 8-10 could be used as a solid coating for a snack-food product, or could be used as an ingredient in the manufacture of such a solid coating. Each of the compositions of examples 7-10, and another example with 15% net protein, were used in the preparation of a solid coating composition. In each of the examples below, the fat content (not including the fat from the cocoa) was maintained at 30%. As more protein was added, the amount of sugar was reduced to keep the batch weight constant from batch to batch. An artificial sweetener product sold under the registered trademark Splenda was added as necessary as sugar was removed. For each example in Table III below, the type of fat used corresponds to the examples of Table II, above. All quantities are in grams unless otherwise stated. The compositions of Examples 11 (control), 13, 14, and 15 were coated on to energy bars in accordance with the parameters reported in Table III. None of these compositions exhibited stickiness when coated onto bars.

TABLE III
Preparation of Coating Composition

| | Example 11 | Example 12 | | | |
|---|---|---|---|---|---|
| | Fat: Ex. 7 | Fat: 15% | Example 13 | Example 14 | Example 15 |
| Ingredient | (control) | protein | Fat: Ex. 8 | Fat: Ex. 9 | Fat: Ex. 10 |
| Coating “Fat” gms | 546 | 672.0 | 870 | 1090 | 1448 |
| Sugar (powdered 6×) (gms) | 923.8 | 792.2 | 588.0 | 361.5 | 0 |
| Cocoa powder (10-12% fat) (gms) | 287 | 287 | 287 | 287 | 280 |
| Non fat dry milk (gms) | 54.5 | 54.5 | 54.5 | 54.5 | 54.5 |
| Extra-fine salt (gms) | 1.5 | 1.5 | 1.5 | 1.5 | 1.5 |
| Lecithin (gms) | 7.20 | 9.0 | 9.0 | 9.0 | 9.0 |
| Artificial sweetener (gms) | 0 | 3.8 | 10.0 | 16.5 | 27.0 |
| % protein in finished coating | 0 | 5.3 | 14.7 | 24.0 | 39.5 |
| Coating application temperature | 117° F. | 118° F. | 118° F. | 118° F. | 118° F. |
| Tunnel temperature | 59° F. | 58° F. | 59° F. | 58° F. | 58° F. |
| % coating deposit based on bar weight | 16.7 | 16.9% | 17.9 | 18.0 | 18.0 |
| Gloss | very good | very good | very good | very good | Good/fine |
| | | | | | lines |

The present invention therefore provides a fat-protein composition that allows about 0-65% protein by weight to be incorporated into a fat composition, and a method of making such a composition, that can be used as a solid coating for a food product or as an ingredient in a solid coating for a food product. Where the food product is a snack food item such as an energy bar, the coating can serve as a moisture barrier to prevent hydration of the protein component of the bar, thereby preserving the energy level of the bar. The protein-rich coating can either add to the protein content of the overall bar, or the protein-rich coating can allow the producer to reduce the protein content of the uncoated bar to make the bar more palatable and still provide the same level of overall protein to the consumer. Depending on the amount of protein in the coating, the amount of protein added to the bar can be in the range of about 5-40%.

An advantage of the present invention is that the coating composition can be applied at temperatures ranging from about 115-125° F., which is higher than the 110° F. coating temperature of certain prior art compositions such as that disclosed in U.S. Pat. No. 4,762,725. The higher application temperature allows a thinner coating to be applied, where desired. Further, the coating of the present invention will not break or crack off the bar, but will still melt in the mouth to provide the desired consumer appeal.

In yet another embodiment, the composition of the present invention can be used in the preparation of a confection such as a toffee-style confection, or a chocolate-candy type confection, but with a higher protein content than traditional confections. Those skilled in the art will recognize from the foregoing disclosure how parameters such as mixing speed, temperature, and proportions of ingredients can be adjusted to create a higher protein confectionery product with a consistency and palatability having appeal to consumers.

The foregoing description and examples are presented by way of illustration and not by way of limitation. Those skilled in the art will recognize that the principles of this invention can be applied in several ways, only a few of which have been exemplified herein, and other modifications and equivalents will be apparent. Accordingly, the scope of the invention is defined by the appended claims.

What is claimed is:

1. A method for forming a composition of a protein particulate material and a lipid-based material, the method comprising the steps of
applying heat and a shear force to said lipid material,
admixing said protein particulate material into said lipid material to form an emulsion of protein material particles in said lipid material,
and cooling said admixed composition, said admixed composition being suitable for use as a solid edible food coating, or as an ingredient for a solid edible food coating.

2. The method of claim 1 wherein said shear force is applied by a mixer rotating at about 4000-8000 rotations per minute.

3. The method of claim 1 wherein said lipid material is heated to a temperature of about 125-165° F. prior to the admixing of said protein particulate material.

4. The method of claim 3 wherein said lipid material is heated to about 125-135° F. prior to the admixing of said protein particulate material.

5. The method of claim 3 wherein said lipid material is heated to about 130° F. prior to the admixing of said protein particulate material.

6. The method of claim 1 wherein said lipid material comprises at least one lipid-containing material selected from the group consisting of palm kernel oil, fractionated palm kernel oil, palm kernel stearine, palm oil, canola oil, cottonseed oil, corn oil, soybean oil, sunflower oil, olive oil, peanut oil, coconut oil, cocoa butter, butter fat, dairy fat, and pure palm kernel stearine fractions, and blends of any of the foregoing.

7. The method of claim 6 wherein said at least one lipid-containing material is non-hydrogenated.

8. The method of claim 6 wherein said at least one lipid-containing material is partially hydrogenated.

9. The method of claim 6 wherein said at least one lipid-containing material is hydrogenated.

10. The method of claim 6 wherein said at least one lipid-containing material is interesterified.

11. The method of claim 6 wherein said at least one lipid-containing material is fractionated.

12. The method of claim 1 wherein said protein particulate material is formed from at least one protein-containing material selected from the group consisting of whey protein concentrate, whey protein isolate, whey protein hydrolysate, soy isolate, soy concentrate, milk casein, calcium caseinate, calcium sodium caseinate, milk protein isolates. beta-lacto globulin, and alpha-lactalbumin.

13. The method of claim 1 wherein said protein particulate material is added in the amount of about 10-65 weight % of said admixed composition.

14. The method of claim 13 wherein said protein particulate composition is added in the amount of about 35-65 weight % of said admixed composition.

15. The method of claim 14 wherein said protein particulate composition is added in the amount of about 50 weight % of said admixed composition.

16. The method of claim 1 comprising the further step of adding an emulsifier in the amount of about 0.6% by weight or less.

17. The method of claim 16 wherein said emulsifier is selected from the group consisting of lecithin and poly glycerol poly ricinoleate (PGPR).

18. The method of claim 16 wherein said emulsifier is selected from the group consisting of only PGPR (0.3% maximum allowed in compound chocolate coating).

19. The method of claim 1 wherein said protein particulate material comprises protein particles in the size range of about 10-70 microns.

20. The method of claim 1 wherein said protein particulate material comprises protein particles in the size range of about −20 microns.

21. An edible composition containing fat and protein and suitable for use as a coating on a food product or in the preparation of a coating for a food product, said composition comprising an emulsion of about 10-65 weight % of a protein particulate material in about 35-90 weight % of a lipid-containing material, and no more than small amounts of an emulsifier.

22. The edible composition of claim 21 wherein said lipid material comprises at least one lipid-containing material selected from the group consisting of palm kernel oil, fractionated palm kernel oil, palm kernel stearine, palm oil, canola oil, cottonseed oil, corn oil, soybean oil, sunflower oil, peanut oil, olive oil, coconut oil, cocoa butter, butter fat, dairy fat, and pure palm kernel stearine fractions.

23. The edible composition of claim 21 wherein said at least one lipid-containing material is non-hydrogenated.

24. The edible composition of claim 21 wherein said at least one lipid-containing material is partially hydrogenated.

25. The edible composition of claim 21 wherein said at least one lipid-containing material is hydrogenated.

26. The edible composition of claim 21 wherein said at least one lipid-containing material is interesterified.

27. The edible composition of claim 21 wherein said at least one lipid containing material is fractionated.

28. The edible composition of claim 21 wherein said protein particulate material is formed from at least one protein-containing material selected from the group consisting of whey protein concentrate, whey protein isolate, whey protein hydrolysate, soy isolate, soy concentrate, milk casein, calcium caseinate, calcium sodium caseinate, milk protein isolates. beta-lacto globulin, and alpha-lactalbumin.

29. The edible composition of claim 21 wherein said protein particulate material is present in the amount of about 10-65 weight % of said admixed composition.

30. The edible composition of claim 29 wherein said protein particulate composition is present in the amount of about 35-65 weight % of said admixed composition.

31. The edible composition of claim 30 wherein said protein particulate composition is present in the amount of about 50 weight % of said admixed composition.

32. The edible composition of claim 21 wherein said emulsifier is selected from the group consisting of lecithin and poly glycerol poly ricinoleate.

33. The edible composition of claim 21 wherein said protein particulate material comprises protein particles in the size range of about −70 microns to about +30 microns.

34. The edible composition of claim 20 wherein said protein particulate material comprises protein particles in the size range of about −20 microns.

35. A food product comprising a coating, said coating comprising a composition containing about 10-65 weight % of a protein particulate material, about 35-90 weight % of a lipid-containing material, and no more than about trace amounts of an emulsifier.
